(19) United States
(12) Patent Application Publication
(10) Pub. No.: US 2024/0356706 A1
(43) Pub. Date: Oct. 24, 2024

(54) TRANSMISSION CONFIGURATION INDICATOR STATE INDICATIONS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/292,601

(22) PCT Filed: Sep. 30, 2021
(86) PCT No.: PCT/CN2021/122215

§ 371 Date: Jan. 26, 2024

(51) Int. Cl. H04L 5/00; H04B 7/06; H04W 36/08

(52) U.S. Cl. CPC H04L 5/0053; H04B 7/06952; H04W 36/085

(57) ABSTRACT

Various aspects of the present disclosure generally relate to wireless communication. In some aspects, a user equipment (UE) may receive an indication of a transmission configuration indicator (TCI) state for non-UE-dedicated communication on a physical channel, the TCI state being shared with UE-dedicated communication on the physical channel or not shared with UE-dedicated communication on the physical channel based at least in part on a rule. The UE may transmit or receive a communication using the TCI state. Numerous other aspects are described.

### FIELD OF THE DISCLOSURE

Aspects of the present disclosure generally relate to wireless communication and specifically, to techniques and apparatuses for indicating a transmission configuration indicator (TCI) state, including for inter-cell beam management.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a transmission configuration indicator (TCI) state for non-UE-dedicated communication on a physical channel, the TCI state being shared with UE-dedicated communication on the physical channel or not shared with UE-dedicated communication on the physical channel based at least in part on a rule. The non-UE-dedicated communication may be in a serving cell. The UE-dedicated communication may be in a serving cell or non-serving cell. The method may include transmitting or receiving a communication using the TCI state.

Some aspects described herein relate to a method of wireless communication performed by a UE. The method may include receiving an indication to activate a TCI state of the UE, the UE operating in one or more of a first mode in which the UE switches in a time domain between communicating using a non-UE-dedicated channel of a serving cell and communicating using a UE-dedicated channel of a non-serving cell, or a second mode in which the UE communicates using both the non-UE-dedicated channel and the UE-dedicated channel. The method may include transmitting or receiving a communication using the TCI state.

Some aspects described herein relate to a method of wireless communication performed by a UE. The method may include transmitting a UE capability report that indicates a maximum quantity of control resource sets (CORESETs) that the UE is able to support for inter-cell beam management. The method may include receiving a configuration that indicates one or more CORESETs that do not exceed the maximum quantity of CORESETs. The method may include receiving an indication of a TCI state that is activated for the one or more CORESETs. The method may include receiving a communication on at least one CORESET of the one or more CORESETs using the TCI state.

Some aspects described herein relate to a method of wireless communication performed by a base station. The method may include receiving, from a UE, a UE capability report that indicates a maximum quantity of CORESETs that the UE is able to support for inter-cell beam management. The method may include transmitting a configuration that indicates a quantity of CORESETs that does not exceed the maximum quantity of CORESETs. The method may include transmitting an indication of a TCI state that is activated for one or more CORESETs. The method may include transmitting a communication on at least one CORESET of the one or more CORESETs using the TCI state.

Some aspects described herein relate to a UE for wireless communication. The UE may include a memory and one or more processors coupled to the memory. The one or more processors may be configured to receive an indication of a TCI state for non-UE-dedicated communication on a physical channel, the TCI state being shared with UE-dedicated communication on the physical channel or not shared with UE-dedicated communication on the physical channel based at least in part on a rule. The one or more processors may be configured to transmit or receive a communication using the TCI state.

Some aspects described herein relate to a UE for wireless communication. The UE may include a memory and one or more processors coupled to the memory. The one or more processors may be configured to receive an indication to activate a TCI state of the UE, the UE operating in one or more of a first mode in which the UE switches in a time domain between communicating using a non-UE-dedicated channel of a serving cell and communicating using a UE-dedicated channel of a non-serving cell, or a second mode in which the UE communicates using both the non-UE-dedicated channel and the UE-dedicated channel. The one or more processors may be configured to transmit or receive a communication using the TCI state.

Some aspects described herein relate to a UE for wireless communication. The UE may include a memory and one or more processors coupled to the memory. The one or more processors may be configured to transmit a UE capability report that indicates a maximum quantity of CORESETs that the UE is able to support for inter-cell beam management. The one or more processors may be configured to receive a configuration that indicates one or more CORESETs that do not exceed the maximum quantity of CORESETs. The one or more processors may be configured to receive an indication of a TCI state that is activated for the one or more CORESETs. The one or more processors may be configured to receive a communication on at least one CORESET of the one or more CORESETs using the TCI state.

Some aspects described herein relate to a base station for wireless communication. The base station may include a memory and one or more processors coupled to the memory. The one or more processors may be configured to receive, from a UE, a UE capability report that indicates a maximum quantity of CORESETs that the UE is able to support for inter-cell beam management. The one or more processors may be configured to transmit a configuration that indicates a quantity of CORESETs that does not exceed the maximum quantity of CORESETs. The one or more processors may be configured to transmit an indication of a TCI state that is activated for one or more CORESETs. The one or more processors may be configured to transmit a communication on at least one CORESET of the one or more CORESETs using the TCI state.

Some aspects described herein relate to a non-transitory computer-readable medium that stores a set of instructions for wireless communication by a UE. The set of instructions, when executed by one or more processors of the UE, may cause the UE to receive an indication of a TCI state for non-UE-dedicated communication on a physical channel, the TCI state being shared with UE-dedicated communication on the physical channel or not shared with UE-dedicated communication on the physical channel based at least in part on a rule. The non-UE-dedicated communication may be in a serving cell. The UE-dedicated communication may be in a serving cell or non-serving cell. The set of instructions, when executed by one or more processors of the UE, may cause the UE to transmit or receive a communication using the TCI state.

Some aspects described herein relate to a non-transitory computer-readable medium that stores a set of instructions for wireless communication by a UE. The set of instructions, when executed by one or more processors of the UE, may cause the UE to receive an indication to activate a TCI state of the UE, the UE operating in one or more of a first mode in which the UE switches in a time domain between communicating using a non-UE-dedicated channel of a serving cell and communicating using a UE-dedicated channel of a non-serving cell, or a second mode in which the UE communicates using both the non-UE-dedicated channel and the UE-dedicated channel. The set of instructions, when executed by one or more processors of the UE, may cause the UE to transmit or receive a communication using the TCI state.

Some aspects described herein relate to a non-transitory computer-readable medium that stores a set of instructions for wireless communication by a UE. The set of instructions, when executed by one or more processors of the UE, may cause the UE to transmit a UE capability report that indicates a maximum quantity of CORESETs that the UE is able to support for inter-cell beam management. The set of instructions, when executed by one or more processors of the UE, may cause the UE to receive a configuration that indicates one or more CORESETs that do not exceed the maximum quantity of CORESETs. The set of instructions, when executed by one or more processors of the UE, may cause the UE to receive an indication of a TCI state that is activated for the one or more CORESETs. The set of instructions, when executed by one or more processors of the UE, may cause the UE to receive a communication on at least one CORESET of the one or more CORESETs using the TCI state.

Some aspects described herein relate to a non-transitory computer-readable medium that stores a set of instructions for wireless communication by a base station. The set of instructions, when executed by one or more processors of the base station, may cause the base station to receive, from a UE, a UE capability report that indicates a maximum quantity of CORESETs that the UE is able to support for inter-cell beam management. The set of instructions, when executed by one or more processors of the base station, may cause the base station to transmit a configuration that indicates a quantity of CORESETs that does not exceed the maximum quantity of CORESETs. The set of instructions, when executed by one or more processors of the base station, may cause the base station to transmit an indication of a TCI state that is activated for one or more CORESETs. The set of instructions, when executed by one or more processors of the base station, may cause the base station to transmit a communication on at least one CORESET of the one or more CORESETs using the TCI state.

Some aspects described herein relate to an apparatus for wireless communication. The apparatus may include means for receiving an indication of a TCI state for non-UE-dedicated communication on a physical channel, the TCI state being shared with UE-dedicated communication on the physical channel or not shared with UE-dedicated communication on the physical channel based at least in part on a rule. The apparatus may include means for transmitting or receiving a communication using the TCI state.

Some aspects described herein relate to an apparatus for wireless communication. The apparatus may include means for receiving an indication to activate a TCI state of the apparatus, the apparatus operating in one or more of, a first mode in which the apparatus switches in a time domain between communicating using a non-UE-dedicated channel of a serving cell and communicating using a UE-dedicated channel of a non-serving cell, or a second mode in which the apparatus communicates using both the non-UE-dedicated channel and the UE-dedicated channel. The apparatus may include means for transmitting or receiving a communication using the TCI state.

Some aspects described herein relate to an apparatus for wireless communication. The apparatus may include means for transmitting a UE capability report that indicates a maximum quantity of CORESETs that the apparatus is able to support for inter-cell beam management. The apparatus may include means for receiving a configuration that indicates one or more CORESETs that do not exceed the maximum quantity of CORESETs. The apparatus may include means for receiving an indication of a TCI state that is activated for the one or more CORESETs. The apparatus may include means for receiving a communication on at least one CORESET of the one or more CORESETs using the TCI state.

Some aspects described herein relate to an apparatus for wireless communication. The apparatus may include means for receiving, from a UE, a UE capability report that indicates a maximum quantity of CORESETs that the UE is able to support for inter-cell beam management. The apparatus may include means for transmitting a configuration that indicates a quantity of CORESETs that does not exceed the maximum quantity of CORESETs. The apparatus may include means for transmitting an indication of a TCI state that is activated for one or more CORESETs. The apparatus may include means for transmitting a communication on at least one CORESET of the one or more CORESETs using the TCI state.

Aspects generally include a method, apparatus, system, computer program product, non-transitory computer-readable medium, UE, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example of using beams for communications between a base station and a UE, in accordance with the present disclosure.

FIG. 4 is a diagram illustrating an example of using a rule for sharing transmission configuration indicator (TCI) states, in accordance with the present disclosure.

FIG. 5 is a diagram illustrating an example of indicating a UE capability for supporting control resource sets, in accordance with the present disclosure.

FIG. 6 is a flowchart illustrating an example process performed, for example, by a UE, in accordance with the present disclosure.

FIG. 7 is a flowchart illustrating an example process performed, for example, by a UE, in accordance with the present disclosure.

FIG. 8 is a flowchart illustrating an example process performed, for example, by a UE, in accordance with the present disclosure.

FIG. 9 is a flowchart illustrating an example process performed, for example, by a base station, in accordance with the present disclosure.

FIGS. 10-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

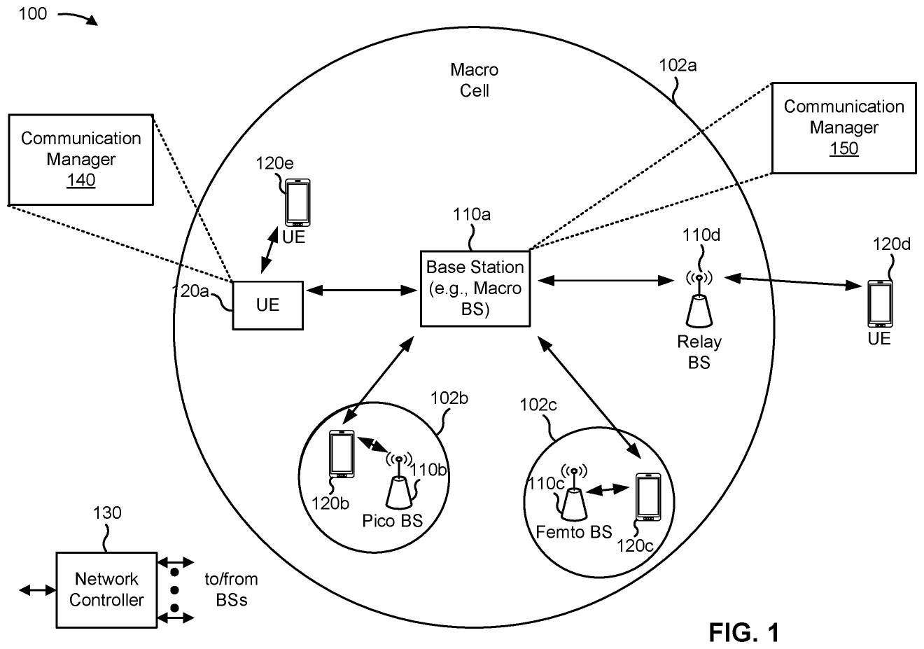

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some examples, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHz-300 GHz). Each of these higher frequency bands falls within the EHF band.

With the above examples in mind, unless specifically stated otherwise, it should be understood that the term “sub-6 GHZ,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive an indication of a transmission configuration indicator (TCI) state for non-UE-dedicated communication on a physical channel, the TCI state being shared with UE-dedicated communication on the physical channel or not shared with UE-dedicated communication on the physical channel based at least in part on a rule. The non-UE-dedicated communication may be in a serving cell. The UE-dedicated communication may be in a serving cell or non-serving cell. The communication manager 140 may transmit or receive a communication using the TCI state. Additionally, or alternatively, the communication manager 140 may perform one or more other operations described herein.

In some aspects, the UE 120 may include a communication manager 140. As described in more detail elsewhere herein, the communication manager 140 may receive an indication to activate a TCI state of the UE, the UE operating in one or more of: a first mode in which the UE switches in a time domain between communicating using a non-UE-dedicated channel of a serving cell and communicating using a UE-dedicated channel of a non-serving cell, or a second mode in which the UE communicates using both the non-UE-dedicated channel and the UE-dedicated channel. The communication manager 140 may transmit or receive a communication using the TCI state. Additionally, or alternatively, the communication manager 140 may perform one or more other operations described herein.

In some aspects, the UE 120 may include a communication manager 140. As described in more detail elsewhere herein, the communication manager 140 may transmit a UE capability report that indicates a maximum quantity of control resource sets (CORESETs) that the UE is able to support for inter-cell beam management. The communication manager 140 may receive a configuration that indicates one or more CORESETs that do not exceed the maximum quantity of CORESETs, receive an indication of a TCI state that is activated for the one or more CORESETs, and receive a communication on at least one CORESET of the one or more CORESETs using the TCI state. Additionally, or alternatively, the communication manager 140 may perform one or more other operations described herein.

In some aspects, the base station 110 may include a communication manager 150. As described in more detail elsewhere herein, the communication manager 150 may receive, from a UE, a UE capability report that indicates a maximum quantity of CORESETs that the UE is able to support for inter-cell beam management. The communication manager 150 may transmit a configuration that indicates a quantity of CORESETs that does not exceed the maximum quantity of CORESETs, transmit an indication of a TCI state that is activated for one or more CORESETs, and transmit a communication on at least one CORESET of the one or more CORESETs using the TCI state. Additionally, or alternatively, the communication manager 150 may perform one or more other operations described herein.

As indicated above, FIG. 1 is provided as an example. Other examples may differ from what is described with regard to FIG. 1.

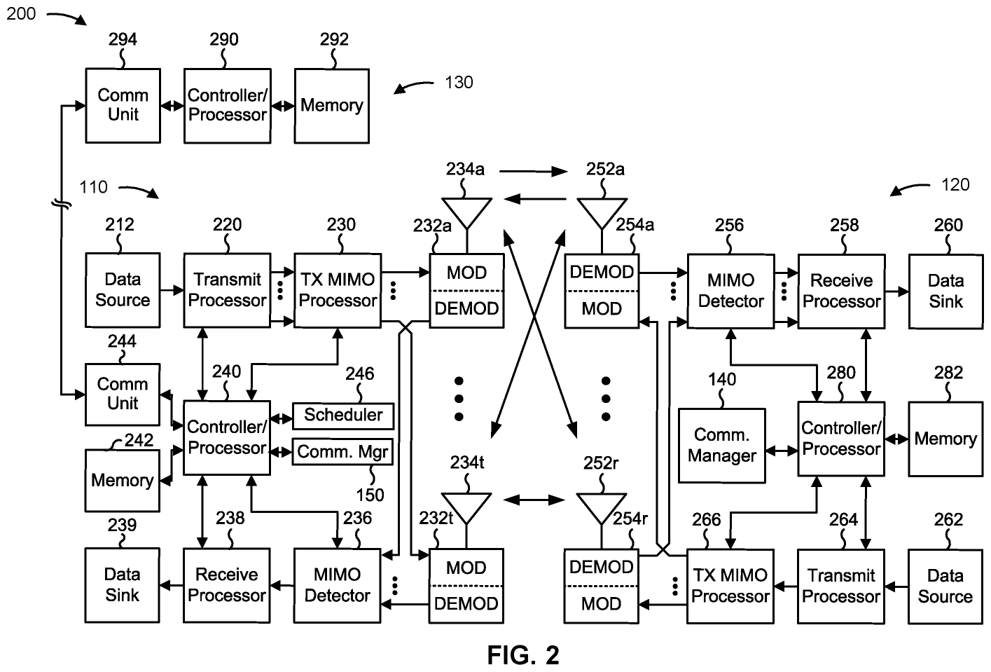

FIG. 2 is a diagram illustrating an example base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

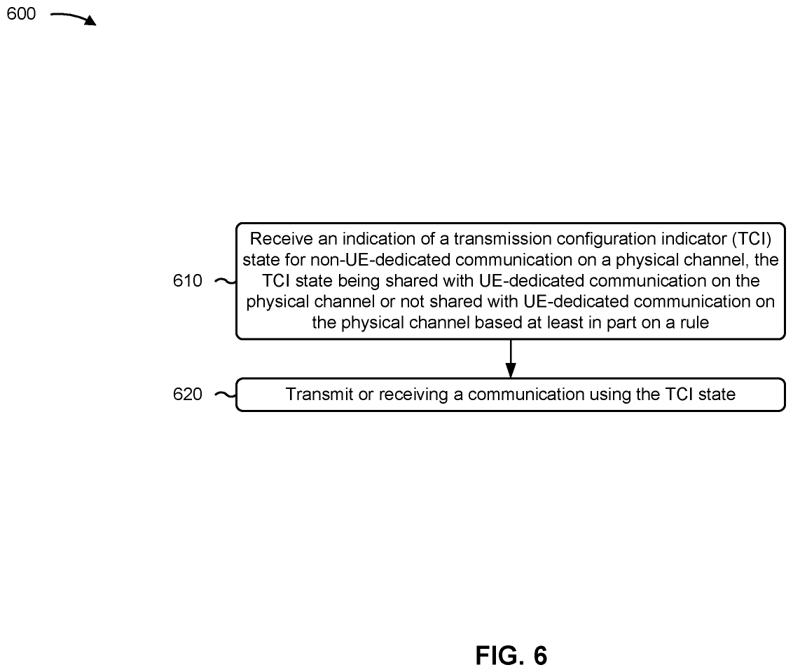

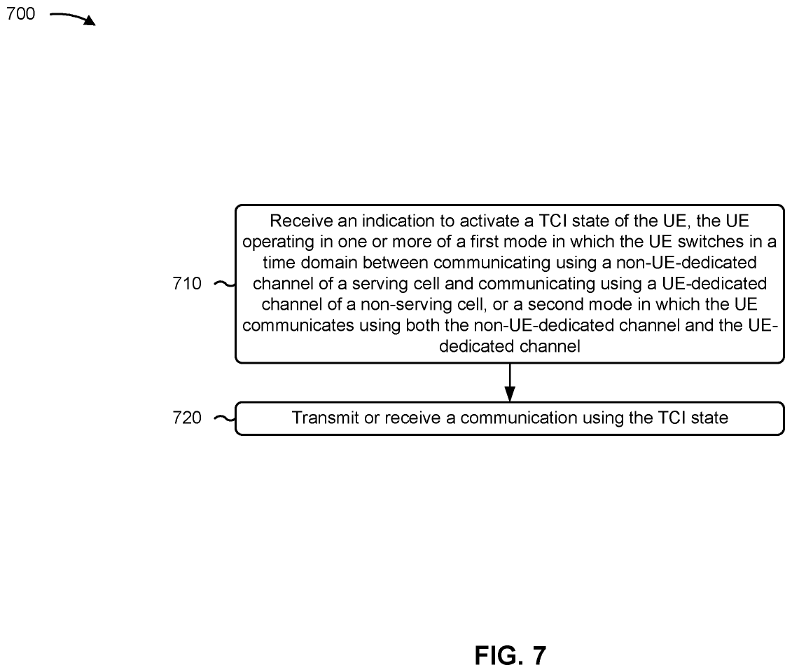

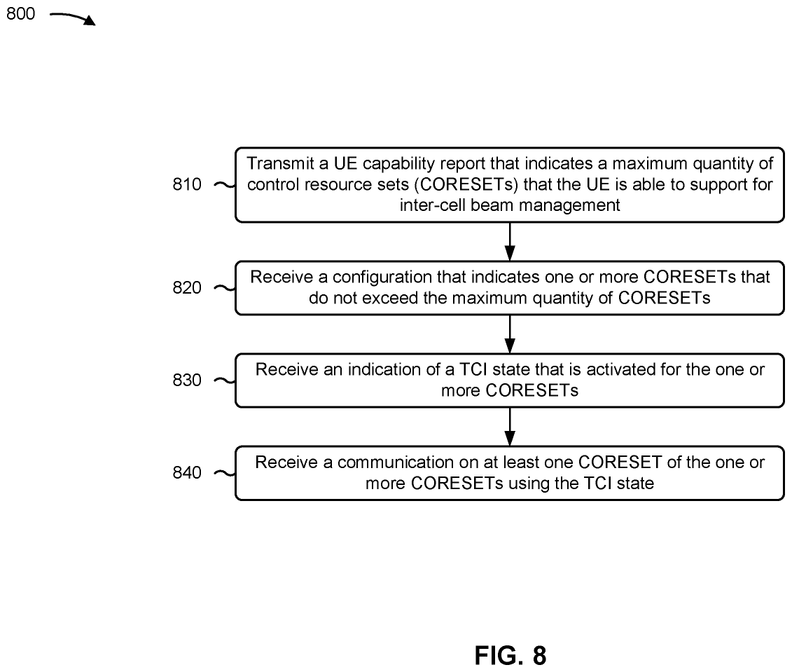

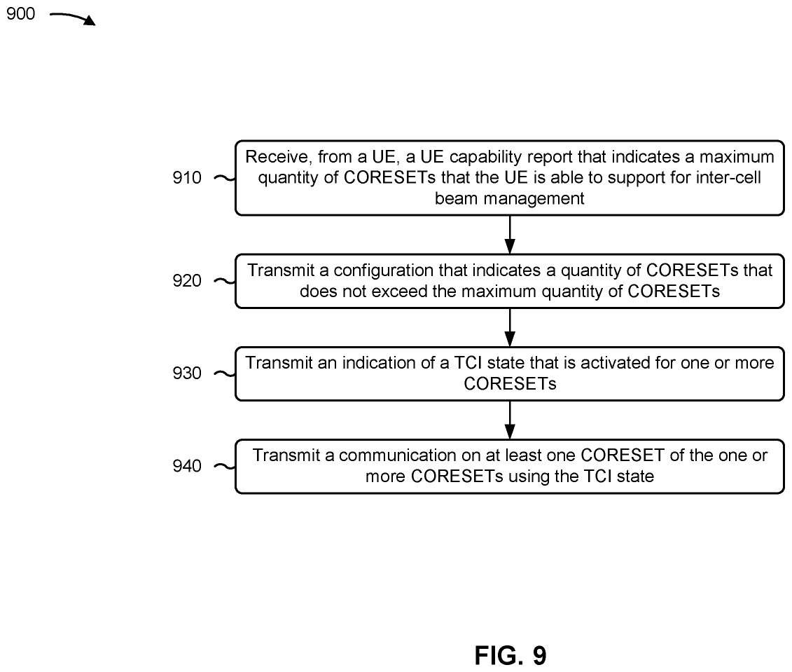

The controller/processor 240 of the base station 110, the controller/processor 280 of the UE 120, or any other component(s) of FIG. 2 may perform one or more techniques associated with indicating TCI states, including for inter-cell beam management, as described in more detail elsewhere herein. For example, the controller/processor 240 of the base station 110, the controller/processor 280 of the UE 120, or any other component(s) of FIG. 2 may perform or direct operations of, for example, process 600 of FIG. 6, process 700 of FIG. 7, process 800 of FIG. 8, process 900 of FIG. 9, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 600 of FIG. 6, process 700 of FIG. 7, process 800 of FIG. 8, process 900 of FIG. 9, or other processes as described herein. In some examples, executing instructions may include running the instructions, converting the instructions, compiling the instructions, or interpreting the instructions, among other examples.

In some aspects, the UE 120 includes means for receiving an indication of a TCI state for non-UE-dedicated communication on a physical channel, the TCI state being shared with UE-dedicated communication on the physical channel or not shared with UE-dedicated communication on the physical channel based at least in part on a rule; and/or means for transmitting or receiving a communication using the TCI state. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving an indication to activate a TCI state of the UE, the UE operating in one or more of a first mode in which the UE switches in a time domain between communicating using a non-UE-dedicated channel of a serving cell and communicating using a UE-dedicated channel of a non-serving cell, or a second mode in which the UE communicates using both the non-UE-dedicated channel and the UE-dedicated channel; and/or means for transmitting or receiving a communication using the TCI state. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for transmitting a UE capability report that indicates a maximum quantity of CORESETs that the UE is able to support for inter-cell beam management; means for receiving a configuration that indicates one or more CORESETs that do not exceed the maximum quantity of CORESETs; means for receiving an indication of a TCI state that is activated for the one or more CORESETs; and/or means for receiving a communication on at least one CORESET of the one or more CORESETs using the TCI state. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for receiving, from a UE, a UE capability report that indicates a maximum quantity of CORESETs that the UE is able to support for inter-cell beam management; means for transmitting a configuration that indicates a quantity of CORESETs that does not exceed the maximum quantity of CORESETs; means for transmitting an indication of a TCI state that is activated for one or more CORESETs; and/or means for transmitting a communication on at least one CORESET of the one or more CORESETs using the TCI state. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

As indicated above, FIG. 2 is provided as an example. Other examples may differ from what is described with regard to FIG. 2.

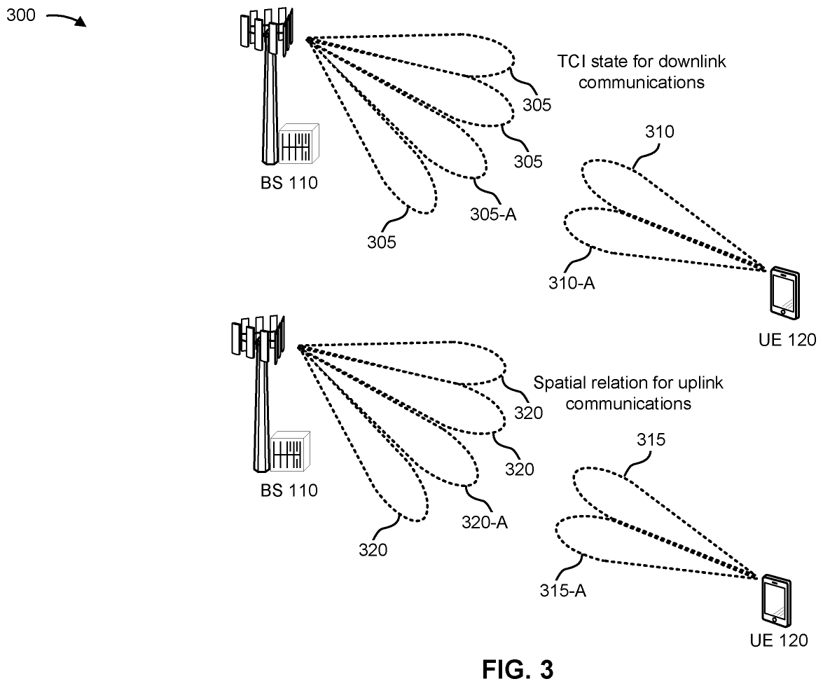

FIG. 3 is a diagram illustrating an example 300 of using beams for communications between a base station and a UE, in accordance with the present disclosure. As shown in FIG. 3, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 305.

The UE 120 may attempt to receive downlink transmissions via one or more UE receive beams 310, which may be configured using different beamforming parameters at receive circuitry of the UE 120. The UE 120 may use a particular BS transmit beam 305, shown as BS transmit beam 305-A, and a particular UE receive beam 310, shown as UE receive beam 310-A, that provide relatively favorable performance (for example, that have a best channel quality of the different measured combinations of BS transmit beams 305 and UE receive beams 310). In some examples, the UE 120 may transmit an indication of which BS transmit beam 305 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 305-A and the UE receive beam 310-A), which may be further refined and maintained in accordance with one or more established beam refinement procedures.

A downlink beam, such as a BS transmit beam 305 or a UE receive beam 310, may be associated with a TCI state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each BS transmit beam 305 may be associated with a synchronization signal block (SSB), and the UE 120 may indicate a preferred BS transmit beam 305 by transmitting uplink transmissions in resources of the SSB that are associated with the preferred BS transmit beam 305. A particular SSB may have an associated TCI state (for example, for an antenna port or for beamforming). The base station 110 may, in some examples, indicate a downlink BS transmit beam 305 based at least in part on antenna port QCL properties that may be indicated by the TCI state. A TCI state may be associated with one downlink RS set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 310 at the UE 120. Thus, the UE 120 may select a corresponding UE receive beam 310 from a set of BPLs based at least in part on the base station 110 indicating a BS transmit beam 305 via a TCI indication. The TCI state may also provide a source reference signal for the UE 120 to determine spatial transmit filters for transmitting uplink channels and/or reference signals.

The base station 110 may maintain a set of activated TCI states for downlink and/or uplink shared channel transmissions and a set of activated TCI states for downlink and/or uplink control channel transmissions. The set of activated TCI states for downlink and/or uplink shared channel transmissions may correspond to beams that the base station 110 uses for downlink transmission on a physical downlink shared channel (PDSCH), downlink transmission on a physical downlink control channel (PDCCH), uplink transmission on a physical uplink shared channel (PUSCH), and/or uplink transmission on a physical uplink control channel (PUCCH). The set of activated TCI states for downlink control channel communications may correspond to beams that the base station 110 may use for downlink transmission on a physical downlink control channel (PDCCH) or in a CORESET. The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 315.

The base station 110 may receive uplink transmissions via one or more BS receive beams 320. The base station 110 may identify a particular UE transmit beam 315, shown as UE transmit beam 315-A, and a particular BS receive beam 320, shown as BS receive beam 320-A, that provide relatively favorable performance (for example, that have a best channel quality of the different measured combinations of UE transmit beams 315 and BS receive beams 320). In some examples, the base station 110 may transmit an indication of which UE transmit beam 315 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 315-A and the BS receive beam 320-A), which may be further refined and maintained in accordance with one or more established beam refinement procedures. An uplink beam, such as a UE transmit beam 315 or a BS receive beam 320, may be associated with a spatial relation. A spatial relation may indicate a directionality or a characteristic of the uplink beam, similar to one or more QCL properties, as described above.

3GPP standards Release 17 is establishing a unified TCI state framework in which a TCI state may be used to indicate more than one beam. The TCI state may be used to indicate beams for a downlink channel or RS and/or an uplink channel or RS. There may be multiple types of unified TCI states. For example, a joint downlink/uplink common TCI state may indicate a common beam for at least one downlink channel or RS and at least one uplink channel or RS. A separate downlink common TCI state may indicate a common beam for more than one downlink channel or RS. A separate uplink common TCI state may indicate a common beam for more than one uplink channel or RS. Other types of unified TCI states may include a separate downlink single channel or RS TCI state that indicates a beam for a single downlink channel or RS, a separate uplink single channel or RS TCI state that indicates a beam for a single uplink channel or RS, or an uplink spatial relation information, such as a spatial relation indicator (SRI), that indicates a beam for a single uplink channel or RS.

Each channel or RS is to have a beam indicated with a TCI state or a spatial relation associated with a TCI state after an RRC connection. A base station may indicate a beam (TCI state) to a UE, or the UE may indicate a beam to the base station. In a unified TCI framework for intra-cell beam management, a downlink RS may share a TCI state with another downlink RS or downlink channel. The downlink channel may be a PDSCH or a PDCCH for UE-dedicated (UE-specific) communication (e.g., transmission, reception). UE-dedicated reception on the PDCCH may be on all or a subset of CORESETs in a component carrier (CC). A base station may transmit a medium access control control element (MAC CE) or downlink control information (DCI) to activate a unified TCI state.

A beam indication may be one of at least two types. An individual beam indication for a single target channel or RS may be referred to as a “single-target beam indication.” This type of beam indication may correspond to the legacy downlink TCI state and spatial relation information in 3GPP standards Release 15 and Release 16, which may be associated with a single target channel or RS for each beam indication. Another type of beam indication may be a simultaneous beam indication for multiple target channels or RSs, referred to as a “multi-target beam indication.” This type of beam indication may correspond to the unified TCI framework introduced in Release 17, which may be indicated to multiple target channels or RSs for each beam indication. Release 17 beam indications may include MAC CE-based signaling or DCI-based signaling (e.g., DCI format 1_1, DCI format 1_2). Release 17 beam indications may be used for intra-cell beam management and for inter-cell beam management, but currently not for non-UE-dedicated (common) communication using the PDSCH or the PDCCH.

Some unified TCI state scenarios may involve uplink channels or uplink RSs. An uplink RS may share a TCI state with UE-dedicated communication on a physical uplink shared channel (PUSCH) or a physical uplink control channel (PUCCH). However, the use of TCI state indications has not been specified for non-UE-dedicated communication on the PUSCH or the PUCCH.

According to various aspects described herein, a base station and a UE may support, in a unified TCI framework, inter-cell beam indications and intra-cell beam indications for non-UE-dedicated channels. The non-UE-dedicated channels may include non-UE-dedicated communication using the PDSCH, non-UE-dedicated communication using the PDCCH, non-UE-dedicated communication using the PUSCH, and non-UE-dedicated communication using the PUCCH. A base station may transmit an indication of a Release 17 TCI state for non-UE-dedicated communication on a physical channel. The TCI state may be shared with UE-dedicated communication on the physical channel or not shared with UE-dedicated communication on the physical channel, based at least in part on a rule. The rule may be configured or received in signaling, such as RRC signaling. If the TCI state for non-UE-dedicated communication on the physical channel is shared with UE-dedicated communication on the physical channel, the base station may use a Release 17 MAC CE-based and/or DCI-based indication to update or configure the TCI state for the non-UE-dedicated communication on the physical channel. If the TCI state for non-UE-dedicated communication on the physical channel is not shared with UE-dedicated communication on the physical channel, the base station may reuse Release 15 or Release 16 signaling to update or configure the TCI state for the non-UE-dedicated communication on the physical channel.

In some aspects, the rule may specify that the TCI state is shared with UE-dedicated communication on the physical channel for inter-cell beam management or for intra-cell beam management. The rule may specify that the TCI state is shared with UE-dedicated communication on the physical channel for inter-cell beam management and not for intra-cell beam management. The rule may specify that the TCI state is shared with UE-dedicated communication on a physical channel for intra-cell beam management and not for inter-cell beam management.

The physical channel may be a physical uplink channel or a physical downlink channel. In some aspects, the rule may specify that the TCI state is shared with UE-dedicated communication on the physical uplink channel or the physical downlink channel. The rule may specify that the TCI state is shared with UE-dedicated communication on a physical uplink channel and not shared with UE-dedicated communication on a physical downlink channel. The rule may specify that the TCI state is shared with UE-dedicated communication on a physical downlink channel and not shared with UE-dedicated communication on a physical uplink channel.

By using a rule to determine whether a TCI state for non-UE-dedicated communication is to be shared with UE-dedicated communication, the base station and the UE may determine what signaling is to be used for indicating a TCI state or selecting a TCI state. As a result, the configuration of non-UE-dedicated beams may be more efficient, which causes the base station and the UE to conserve power, processing resources, and signaling resources.

As indicated above, FIG. 3 is provided as an example. Other examples may differ from what is described with regard to FIG. 3.

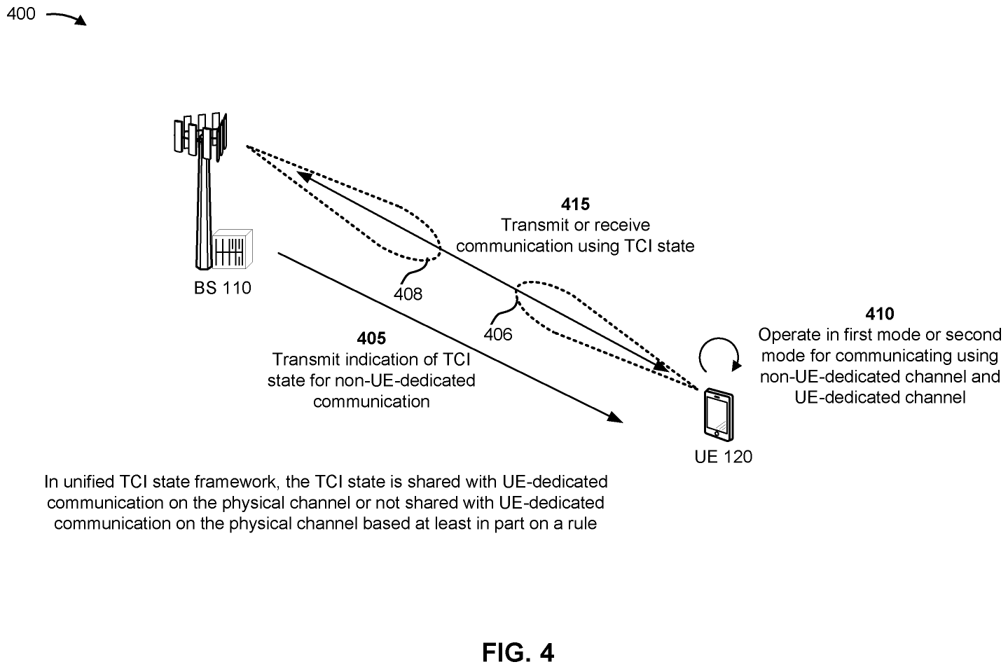

FIG. 4 is a diagram illustrating an example 400 of using a rule for sharing TCI states, in accordance with the present disclosure. A base station, such as base station 110, may communicate with a UE, such as UE 120.

As shown by reference number 405, the base station 110 may transmit an indication of a TCI state for non-UE-dedicated (common) communication on a physical channel. The TCI state for non-UE-dedicated communication may be shared with UE-dedicated communication or not shared with UE-dedicated communication based at least in part on a rule. The rule may be based at least in part on whether the TCI state is for inter-cell beam management, intra-cell beam management, or both. The rule may also be based at least in part on whether the non-UE-dedicated communication uses a physical uplink channel (e.g., PUSCH, PUCCH) or a physical downlink channel (e.g., PDSCH, PDCCH). The rule may affect what signaling is used by the base station 110 to indicate the TCI state and/or for which communications (non-UE-dedicated and/or UE-dedicated) the UE 120 is to use the TCI state. The UE 120 may use the indicated TCI state to form a receive beam 406 or a transmit beam 408.

In some aspects, the UE 120 may support only one active TCI state for inter-cell beam management. If only one active TCI state is supported, the UE 120 may operate in one of at least two modes when communicating (transmitting or receiving) using a non-UE-dedicated channel of a serving cell and a UE-dedicated channel of a non-serving cell, as shown by reference number 410. In a first mode, the UE 120 may switch in a time domain (using time division multiplexing (TDM)) between communicating using the non-UE-dedicated channel of the serving cell and communicating using the UE-dedicated channel of the non-serving cell. In a second mode, the UE 120 may communicate using both the non-UE-dedicated channel of the serving cell and the UE-dedicated channel of the serving cell. In some aspects, the base station 110 may transmit a DCI, MAC CE or an RRC message that indicates that the UE is to switch from the first mode to the second mode, to switch from the second mode to the first mode, or to operate in both the first mode and the second mode.

In some aspects, if the UE 120 is operating in the first mode, the TCI state may be associated with the serving cell and the non-UE-dedicated channel is of the serving cell. Alternatively, if the UE 120 is operating in the first mode, the TCI state may be associated with the non-serving cell and the UE-dedicated channel is of the non-serving cell. In some aspects, if the UE 120 is operating in the first mode, the UE 120 may receive a first MAC CE that activates a first TCI state for the non-UE-dedicated channel of the serving cell and receive a second MAC CE that activates a second TCI state for the UE-dedicated channel of the non-serving cell. In this way, the UE 120 may use different TCI states to communicate with the non-UE-dedicated channel of the serving cell and the UE-dedicated channel of the non-serving cell in a TDM manner.

In some aspects, the UE 120 may follow a rule when operating in the first mode. For example, the rule may specify that the UE does not receive (or expect to receive) the non-UE-dedicated channel of the serving cell if the TCI state is activated for the UE-dedicated channel of the non-serving cell. The rule for the first mode may specify that the UE 120 receives the non-UE-dedicated channel of the serving cell in the corresponding reception occasions using the TCI state that is activated for the UE-dedicated channel of the non-serving cell. The rule for the first mode may specify that the UE 120 does not receive (or expect to receive) the UE-dedicated channel of the non-serving cell if the TCI state is activated for the non-UE-dedicated channel of the serving cell. The rule for the first mode may specify that the UE 120 receives the UE-dedicated channel of the non-serving cell in the corresponding reception occasions using the TCI state that is activated for the non-UE-dedicated channel of the serving cell.

In some aspects, the UE 120 may operate in the second mode, and the TCI state may be associated with the serving cell. The UE 120 may receive a first MAC CE that activates a first TCI state and a second MAC CE activates a second TCI state that updates the first TCI state.

As shown by reference number 415, the UE 120 may transmit or receive a communication using the TCI state. The UE 120 may transmit or receive the communication for the non-UE-dedicated channel and transmit or receive a communication for the UE-dedicated channel based at least in part on the operational mode of the UE 120.

In some aspects, the UE 120 may reduce latency with TCI switching in inter-cell beam management, and TCI switching may occur without explicit TCI activation. The UE 120 may be provided with two TCI states (e.g., by a single MAC-CE), where different TCI states may be activated at different times. In scenarios where the first TCI state is to be activated for receiving the UE-dedicated channel of the non-serving cell, the UE 120 may receive another indication (e.g., TCI activation MAC CE) to switch to the second TCI state for receiving the non-UE-dedicated channel of the serving cell. The UE 120 may switch back to receive the UE-dedicated channel of the non-serving cell using the first TCI state upon expiration of a timer associated with the second TCI. The timer may help to avoid the use of a third MAC CE to switch back. The timer may be set to accommodate the time for applying TCI state activation or TCI state switching. Alternatively, or additionally, the UE 120 may switch, according to a periodic switching configuration, to the second TCI state for receiving the non-UE-dedicated channel of the serving cell in the corresponding reception occasions and then switch back to receive the UE-dedicated channel of the non-serving cell using the first TCI state upon expiration of a timer associated with the second TCI state. The periodic switching according to the timer may help to avoid use of a second MAC CE for switching and a third MAC CE for switching back. Avoiding MAC CEs conserves processing resources and reduces latency.

In some aspects, the first TCI state is for receiving a UE-dedicated channel of the serving cell and a non-UE dedicated channel of the serving cell, and the second TCI state is for receiving a UE-dedicated channel of the non-serving cell. In some aspect, the UE 120 may receive a TCI indication DCI to switch between the first mode and the second mode. For example, the UE 120 may receive a first DCI to indicate the first TCI state, such that the UE may be switched in the second mode to communicate with the non-UE-dedicated channel of the serving cell and the UE-dedicated channel of the serving cell using the first TCI state. The UE 120 may receive a second DCI to indicate the second TCI state, such that the UE may be switched in the first mode to communicate with the non-UE-dedicated channel of the serving cell using the first TCI state and communicate with the UE-dedicated channel of the non-serving cell using the second TCI state.

As indicated above, FIG. 4 is provided as an example. Other examples may differ from what is described with regard to FIG. 4, including other rules for operating in the first mode or the second mode.

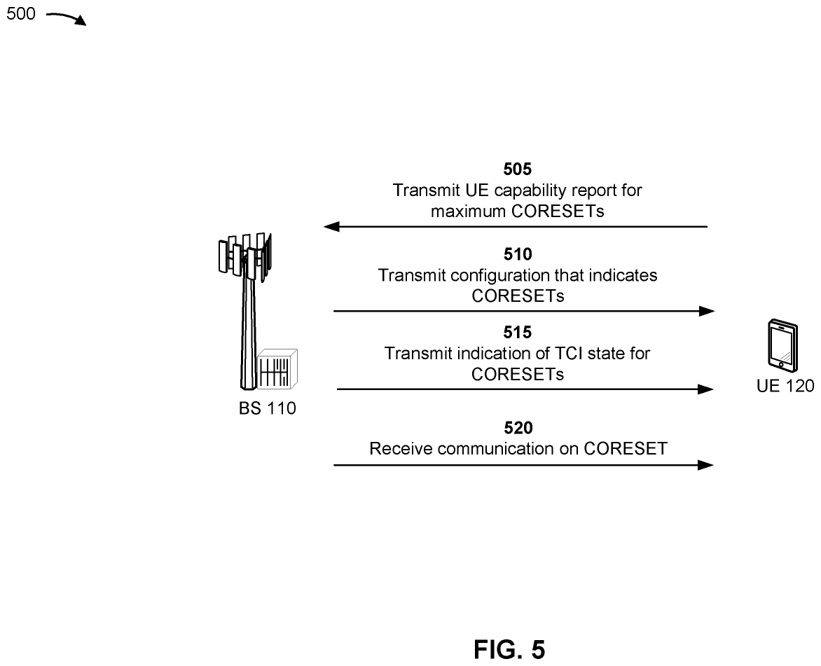

FIG. 5 is a diagram illustrating an example 500 of indicating a UE capability for supporting CORESETs, in accordance with the present disclosure. A base station, such as the base station 110, may communicate with a UE, such as the UE 120.

For a non-UE-dedicated (common) channel of a serving cell, the UE 120 may receive an indication of a TCI state that is associated with the serving cell. For a UE-dedicated (UE-specific) channel of a serving cell, the UE 120 may receive an indication of a TCI state that is associated with the serving cell. The channel may be a PDCCH, and one or more CORESETs may be associated with the PDCCH. Also, DMRSs may be associated with non-UE-dedicated reception on one or more CORESETs that are configured for the PDCCH. However, the UE 120 may be limited as to how may CORESETs the UE 120 is able to support in the serving cell or the non-serving cell.

The UE 120 may inform the base station 110 of a UE capability of the UE 120 for supporting a configuration for CORESETs. As shown by reference number 505, the UE 120 may transmit an indication of the UE capability. The UE capability may include a maximum quantity of supported CORESETs per component carrier (CC) or among all CCs. The UE capability may include a maximum quantity of supported CORESETs with a non-UE-dedicated (common) search space (SS) and/or a maximum quantity of supported CORESETs with a UE-dedicated search space. For example, the UE 120 may support two CORESETs, with one CORESET associated with the non-UE-dedicated SS and one CORESET associated with the UE-dedicated SS. The UE capability may include a maximum quantity of supported CORESETs for the non-serving cell and/or for the serving cell.

As shown by reference number 510, the base station 110 may transmit a configuration to the UE 120 that indicates one or more CORESETs. The quantity of the one or more CORESETs may not exceed the maximum quantity of CORESETs. As shown by reference number 515, the base station 110 may transmit an indication of a TCI state that is activated for at least one of the one or more CORESETs. As shown by reference number 520, the UE 120 may receive a communication on the at least one CORESET. By indicating a UE capability of supporting CORESETs, the UE 120 may avoid scenarios where there are too many CORESETs for the UE 120 to support with respect to TCI states. As a result, the UE 120 may conserve processing resources and signaling resources.

As indicated above, FIG. 5 is provided as an example. Other examples may differ from what is described with regard to FIG. 5, including other ways to indicate support for TCI states for CORESETs.

FIG. 6 is a diagram illustrating an example process 600 performed, for example, by a UE, in accordance with the present disclosure. Example process 600 is an example where the UE (e.g., UE 120) performs operations associated with indicating TCI states.

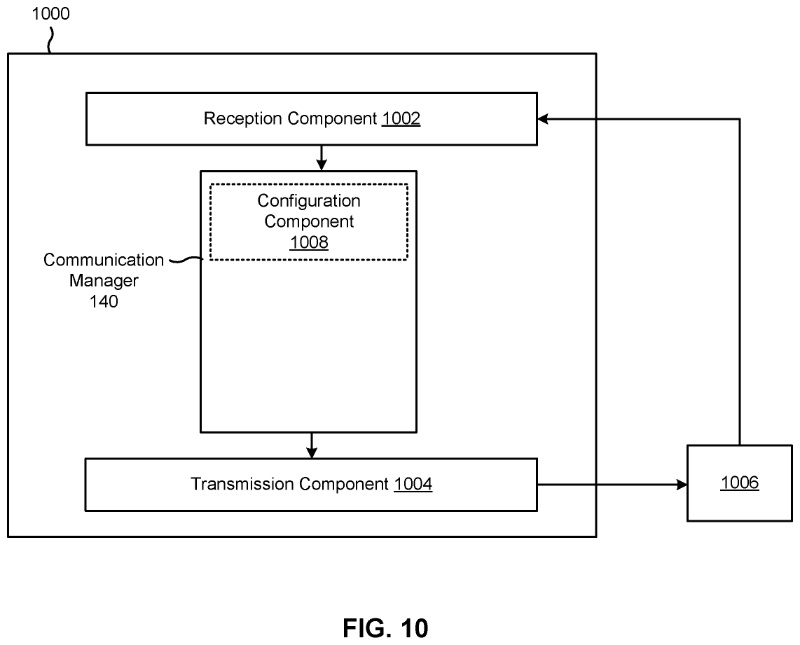

As shown in FIG. 6, in some aspects, process 600 may include receiving an indication of a TCI state for non-UE-dedicated communication on a physical channel, the TCI state being shared with UE-dedicated communication on the physical channel or not shared with UE-dedicated communication on the physical channel based at least in part on a rule (block 610). For example, the UE (e.g., using communication manager 140 and/or reception component 1002 depicted in FIG. 10) may receive an indication of a TCI state for non-UE-dedicated communication on a physical channel, the TCI state being shared with UE-dedicated communication on the physical channel or not shared with UE-dedicated communication on the physical channel based at least in part on a rule, as described above.

As further shown in FIG. 6, in some aspects, process 600 may include transmitting or receiving a communication using the TCI state (block 620). For example, the UE (e.g., using communication manager 140 and/or transmission component 1004 depicted in FIG. 10) may transmit or receive a communication using a rule for sharing a TCI state, as described above.

Process 600 may include additional aspects, such as any single aspect or any combination of aspects described below and/or in connection with one or more other processes described elsewhere herein.

In a first aspect, the rule specifies that the TCI state is shared with UE-dedicated communication on the physical channel for inter-cell beam management or for intra-cell beam management.

In a second aspect, alone or in combination with the first aspect, the rule specifies that the TCI state is shared with UE-dedicated communication on a physical channel for inter-cell beam management and not for intra-cell beam management.

In a third aspect, alone or in combination with one or more of the first and second aspects, the rule specifies that the TCI state is shared with UE-dedicated communication on a physical channel for intra-cell beam management and not for inter-cell beam management.

In a fourth aspect, alone or in combination with one or more of the first through third aspects, the physical channel is a physical uplink channel or a physical downlink channel, and the rule specifies that the TCI state is shared with UE-dedicated communication on the physical uplink channel or the physical downlink channel.

In a fifth aspect, alone or in combination with one or more of the first through fourth aspects, the rule specifies that the TCI state is shared with UE-dedicated communication on a physical uplink channel and not shared with UE-dedicated communication on a physical downlink channel.

In a sixth aspect, alone or in combination with one or more of the first through fifth aspects, the rule specifies that the TCI state is shared with UE-dedicated communication on a physical downlink channel and not shared with UE-dedicated communication on a physical uplink channel.

In a seventh aspect, alone or in combination with one or more of the first through sixth aspects, the TCI state is shared between UE-dedicated communication on the physical channel and non-UE-dedicated communication on the physical channel, and receiving the indication of the TCI state includes receiving the indication of the TCI state via a MAC CE or DCI.

In an eighth aspect, alone or in combination with one or more of the first through seventh aspects, the TCI state is not shared between UE-dedicated communication on the physical channel and non-UE-dedicated communication on the physical channel, and receiving the indication of the TCI state includes receiving the indication of the TCI state via a MAC CE or an RRC message.

In a ninth aspect, alone or in combination with one or more of the first through eighth aspects, the TCI state is a unified TCI state that indicates a common beam for at least one downlink channel or downlink RS and at least one uplink channel or uplink RS.

In a tenth aspect, alone or in combination with one or more of the first through ninth aspects, the TCI state is a unified TCI state that indicates a common beam for more than one downlink channel or downlink RS or more than one uplink channel or uplink RS.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by an UE, in accordance with the present disclosure. Example process 700 is an example where the UE (e.g., UE 120) performs operations associated with operational modes for using TCI state indications.

As shown in FIG. 7, in some aspects, process 700 may include receiving an indication to activate a TCI state of the UE, the UE operating in one or more of: a first mode in which the UE switches in a time domain between communicating using a non-UE-dedicated channel of a serving cell and communicating using a UE-dedicated channel of a non-serving cell, or a second mode in which the UE communicates using both the non-UE-dedicated channel and the UE-dedicated channel (block 710). For example, the UE (e.g., using communication manager 140 and/or reception component 1002 depicted in FIG. 10) may receive an indication to activate a TCI state of the UE, the UE operating in one or more of: a first mode in which the UE switches in a time domain between communicating using a non-UE-dedicated channel of a serving cell and communicating using a UE-dedicated channel of a non-serving cell, or a second mode in which the UE communicates using both the non-UE-dedicated channel and the UE-dedicated channel, as described above.

As further shown in FIG. 7, in some aspects, process 700 may include transmitting or receiving a communication using the TCI state (block 720). For example, the UE (e.g., using communication manager 140 and/or transmission component 1004 depicted in FIG. 10) may transmit or receive a communication using the TCI state, as described above.

Process 700 may include additional aspects, such as any single aspect or any combination of aspects described below and/or in connection with one or more other processes described elsewhere herein.

In a first aspect, the UE supports no more than one active TCI state for inter-cell beam management, and process 700 includes receiving a MAC CE or a radio resource control message that indicates that the UE is to switch from the first mode to the second mode, to switch from the second mode to the first mode, or to operate in both the first mode and the second mode.

In a second aspect, alone or in combination with the first aspect, if the UE is operating in the first mode, the TCI state is associated with the serving cell and the non-UE-dedicated channel is of the serving cell.

In a third aspect, alone or in combination with one or more of the first and second aspects, if the UE is operating in the first mode, the TCI state is associated with the non-serving cell and the UE-dedicated channel is of the non-serving cell.

In a fourth aspect, alone or in combination with one or more of the first through third aspects, the UE is operating in the first mode, and receiving the indication includes receiving a MAC CE that activates the TCI state for the non-UE-dedicated channel of the serving cell, and receiving a MAC CE that activates the TCI state for the UE-dedicated channel of the non-serving cell.

In a fifth aspect, alone or in combination with one or more of the first through fourth aspects, a rule for the first mode specifies that the UE does not receive the non-UE-dedicated channel of the serving cell if the TCI state is activated for the UE-dedicated channel of the non-serving cell.

In a sixth aspect, alone or in combination with one or more of the first through fifth aspects, a rule for the first mode specifies that the UE receives the non-UE-dedicated channel of the serving cell using the TCI state that is activated for the UE-dedicated channel of the non-serving cell.

In a seventh aspect, alone or in combination with one or more of the first through sixth aspects, a rule for the first mode specifies that the UE does not receive the UE-dedicated channel of the non-serving cell if the TCI state is activated for the non-UE-dedicated channel of the serving cell.

In an eighth aspect, alone or in combination with one or more of the first through seventh aspects, a rule for the first mode specifies that the UE receives the UE-dedicated channel of the non-serving cell using the TCI state that is activated for the non-UE-dedicated channel of the serving cell.

In a ninth aspect, alone or in combination with one or more of the first through eighth aspects, the UE is operating in the second mode, and the TCI state is associated with the serving cell.

In a tenth aspect, alone or in combination with one or more of the first through ninth aspects, the UE is operating in the second mode, and receiving the indication includes receiving a first MAC CE that activates the TCI state.

In an eleventh aspect, alone or in combination with one or more of the first through tenth aspects, process 700 includes receiving a second MAC CE that updates the TCI state.

In a twelfth aspect, alone or in combination with one or more of the first through eleventh aspects, the TCI state is for the UE-dedicated channel of the non-serving cell, and process 700 includes receiving another indication to switch to another TCI state for the non-UE-dedicated channel of the serving cell, and switching back to the TCI state for the UE-dedicated channel of the non-serving cell upon expiration of a timer.

In a thirteenth aspect, alone or in combination with one or more of the first through twelfth aspects, the TCI state is for the UE-dedicated channel of the non-serving cell, and process 700 includes switching, according to a periodic switching configuration, to another TCI state for the non-UE-dedicated channel of the serving cell, and switching back to the TCI state for the UE-dedicated channel of the non-serving cell upon expiration of a timer.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by an UE, in accordance with the present disclosure. Example process 800 is an example where the UE (e.g., UE 120) performs operations associated with indicating a UE capability for CORESETs associated with TCI states.

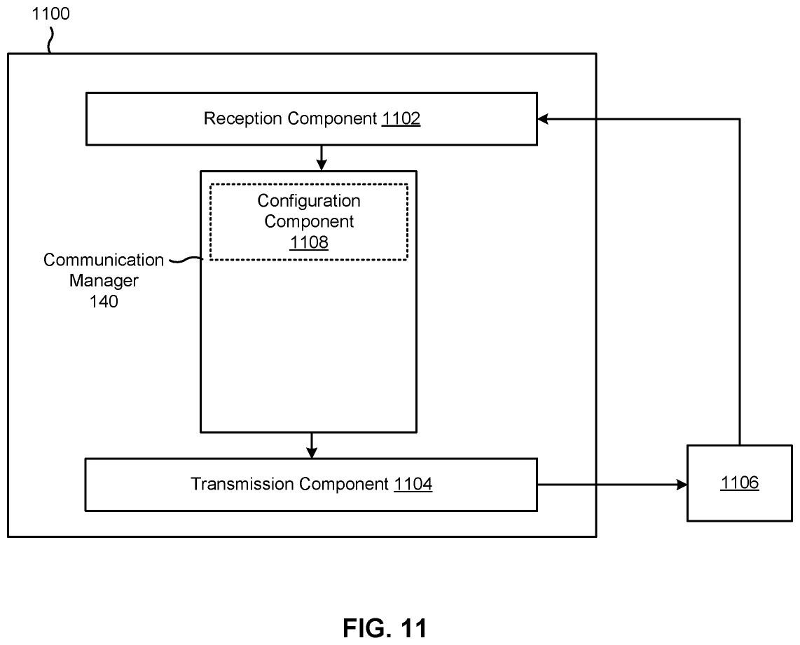

As shown in FIG. 8, in some aspects, process 800 may include transmitting a UE capability report that indicates a maximum quantity of CORESETs that the UE is able to support for inter-cell beam management (block 810). For example, the UE (e.g., using communication manager 140 and/or transmission component 1104 depicted in FIG. 11) may transmit a UE capability report that indicates a maximum quantity of CORESETs that the UE is able to support for inter-cell beam management, as described above.

As further shown in FIG. 8, in some aspects, process 800 may include receiving a configuration that indicates one or more CORESETs that do not exceed the maximum quantity of CORESETs (block 820). For example, the UE (e.g., using communication manager 140 and/or reception component 1102 depicted in FIG. 11) may receive a configuration that indicates one or more CORESETs that do not exceed the maximum quantity of CORESETs, as described above.

As further shown in FIG. 8, in some aspects, process 800 may include receiving an indication of a TCI state that is activated for the one or more CORESETs (block 830). For example, the UE (e.g., using communication manager 140 and/or reception component 1102 depicted in FIG. 11) may receive an indication of a TCI state that is activated for the one or more CORESETs, as described above.

As further shown in FIG. 8, in some aspects, process 800 may include receiving a communication on at least one CORESET of the one or more CORESETs using the TCI state (block 840). For example, the UE (e.g., using communication manager 140 and/or reception component 1102 depicted in FIG. 11) may receive a communication on at least one CORESET of the one or more CORESETs using the TCI state, as described above.

Process 800 may include additional aspects, such as any single aspect or any combination of aspects described below and/or in connection with one or more other processes described elsewhere herein.

In a first aspect, the maximum quantity of CORESETs includes a maximum quantity of CORESETs supported per component carrier or a maximum quantity of CORESETs supported among all component carriers.

In a second aspect, alone or in combination with the first aspect, the maximum quantity of CORESETs includes a maximum quantity of CORESETs supported for a non-UE-dedicated search space or a maximum quantity of CORESETs supported for a UE-dedicated search space.

In a third aspect, alone or in combination with one or more of the first and second aspects, the maximum quantity of CORESETs includes a maximum quantity of CORESETs supported for a serving cell or a maximum quantity of CORESETs supported for a non-serving cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with using a UE capability to configure CORESETs.

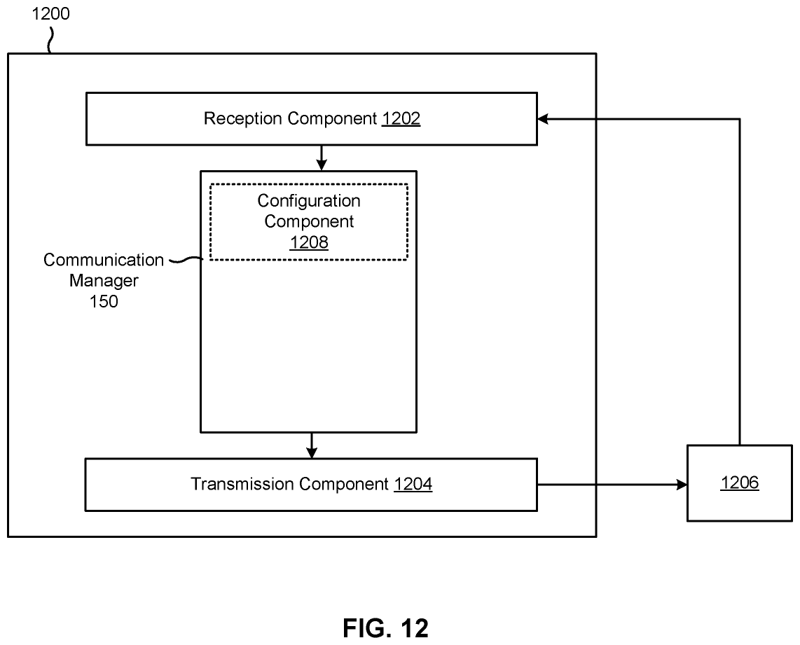

As shown in FIG. 9, in some aspects, process 900 may include receiving, from a UE, a UE capability report that indicates a maximum quantity of CORESETs that the UE is able to support for inter-cell beam management (block 910). For example, the base station (e.g., using communication manager 150 and/or reception component 1202 depicted in FIG. 12) may receive, from a UE, a UE capability report that indicates a maximum quantity of CORESETs that the UE is able to support for inter-cell beam management, as described above.

As further shown in FIG. 9, in some aspects, process 900 may include transmitting a configuration that indicates a quantity of CORESETs that does not exceed the maximum quantity of CORESETs (block 920). For example, the base station (e.g., using communication manager 150 and/or transmission component 1204 depicted in FIG. 12) may transmit a configuration that indicates a quantity of CORESETs that does not exceed the maximum quantity of CORESETs, as described above.

As further shown in FIG. 9, in some aspects, process 900 may include transmitting an indication of a TCI state that is activated for one or more CORESETs (block 930). For example, the base station (e.g., using communication manager 150 and/or transmission component 1204 depicted in FIG. 12) may transmit an indication of a TCI state that is activated for one or more CORESETs, as described above.

As further shown in FIG. 9, in some aspects, process 900 may include transmitting a communication on at least one CORESET of the one or more CORESETs using the TCI state (block 940). For example, the base station (e.g., using communication manager 150 and/or transmission component 1204 depicted in FIG. 12) may transmit a communication on at least one CORESET of the one or more CORESETs using the TCI state, as described above.

Process 900 may include additional aspects, such as any single aspect or any combination of aspects described below and/or in connection with one or more other processes described elsewhere herein.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE (e.g., UE 120), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a configuration component 1008, among other examples.

In some aspects, the apparatus 1000 may be configured to perform one or more operations described herein in connection with FIGS. 1-5. Additionally, or alternatively, the apparatus 1000 may be configured to perform one or more processes described herein, such as process 600 of FIG. 6, process 700 of FIG. 7, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive an indication of a TCI state for non-UE-dedicated communication on a physical channel, the TCI state being shared with UE-dedicated communication on the physical channel or not shared with UE-dedicated communication on the physical channel based at least in part on a rule. The configuration component 1008 may configure one or more antennas of the apparatus 1000 according to the TCI state. The transmission component 1004 may transmit or receive a communication using the TCI state.

The reception component 1002 may receive an indication to activate a TCI state of the UE, the UE operating in one or more of a first mode in which the UE switches in a time domain between communicating using a non-UE-dedicated channel of a serving cell and communicating using a UE-dedicated channel of a non-serving cell, or a second mode in which the UE communicates using both the non-UE-dedicated channel and the UE-dedicated channel. The configuration component 1008 may configure one or more antennas of the apparatus 1000 according to the TCI state. The transmission component 1004 may transmit or receive a communication using the TCI state. The reception component 1002 may receive a second MAC CE that updates the TCI state.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a UE (e.g., UE 120), or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include a configuration component 1108, among other examples.

In some aspects, the apparatus 1100 may be configured to perform one or more operations described herein in connection with FIGS. 1-5. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The transmission component 1104 may transmit a UE capability report that indicates a maximum quantity of CORESETs that the UE is able to support for inter-cell beam management. The reception component 1102 may receive a configuration that indicates one or more CORESETs that do not exceed the maximum quantity of CORESETs. The reception component 1102 may receive an indication of a TCI state that is activated for the one or more CORESETs. The configuration component 1108 may configure one or more antennas of the apparatus 1000 according to the TCI state. The reception component 1102 may receive a communication on at least one CORESET of the one or more CORESETs using the TCI state.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a base station (e.g., base station 110), or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a configuration component 1208, among other examples.

In some aspects, the apparatus 1200 may be configured to perform one or more operations described herein in connection with FIGS. 1-5. Additionally, or alternatively, the apparatus 1200 may be configured to perform one or more processes described herein, such as process 900 of FIG. 9. In some aspects, the apparatus 1200 and/or one or more components shown in FIG. 12 may include one or more components of the base station described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

The reception component 1202 may receive, from a UE, a UE capability report that indicates a maximum quantity of CORESETs that the UE is able to support for inter-cell beam management. The configuration component 1208 may generate a configuration that indicates a quantity of CORESETs that does not exceed the maximum quantity of CORESETs. The transmission component 1204 may transmit the configuration. The transmission component 1204 may transmit an indication of a TCI state that is activated for one or more CORESETs. The transmission component 1204 may transmit a communication on at least one CORESET of the one or more CORESETs using the TCI state.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving an indication of a transmission configuration indicator (TCI) state for non-UE-dedicated communication on a physical channel, the TCI state being shared with UE-dedicated communication on the physical channel or not shared with UE-dedicated communication on the physical channel based at least in part on a rule; and transmitting or receiving a communication using the TCI state.
Aspect 2: The method of Aspect 1, wherein the rule specifies that the TCI state is shared with UE-dedicated communication on the physical channel for inter-cell beam management or for intra-cell beam management.
Aspect 3: The method of Aspect 1, wherein the rule specifies that the TCI state is shared with UE-dedicated communication on a physical channel for inter-cell beam management and not for intra-cell beam management.
Aspect 4: The method of Aspect 1, wherein the rule specifies that the TCI state is shared with UE-dedicated communication on a physical channel for intra-cell beam management and not for inter-cell beam management.
Aspect 5: The method of any of Aspects 1-4, wherein the physical channel is a physical uplink channel or a physical downlink channel, and wherein the rule specifies that the TCI state is shared with UE-dedicated communication on the physical uplink channel or the physical downlink channel.
Aspect 6: The method of any of Aspects 1-4, wherein the rule specifies that the TCI state is shared with UE-dedicated communication on a physical uplink channel and not shared with UE-dedicated communication on a physical downlink channel.
Aspect 7: The method of any of Aspects 1-4, wherein the rule specifies that the TCI state is shared with UE-dedicated communication on a physical downlink channel and not shared with UE-dedicated communication on a physical uplink channel.
Aspect 8: The method of any of Aspects 1-7, wherein the TCI state is shared between UE-dedicated communication on the physical channel and non-UE-dedicated communication on the physical channel, and wherein receiving the indication of the TCI state includes receiving the indication of the TCI state via a medium access control control element (MAC CE) or downlink control information.
Aspect 9: The method of any of Aspects 1-7, wherein the TCI state is not shared between UE-dedicated communication on the physical channel and non-UE-dedicated communication on the physical channel, and wherein receiving the indication of the TCI state includes receiving the indication of the TCI state via a medium access control control element (MAC CE) or a radio resource control message.
Aspect 10: The method of any of Aspects 1-9, wherein the TCI state is a unified TCI state that indicates a common beam for at least one downlink channel or downlink reference signal (RS) and at least one uplink channel or uplink RS.
Aspect 11: The method of any of Aspects 1-9, wherein the TCI state is a unified TCI state that indicates a common beam for more than one downlink channel or downlink RS or more than one uplink channel or uplink RS.
Aspect 12: A method of wireless communication performed by a user equipment (UE), comprising: receiving an indication to activate a transmission configuration indicator (TCI) state of the UE, the UE operating in one or more of: a first mode in which the UE switches in a time domain between communicating using a non-UE-dedicated channel of a serving cell and communicating using a UE-dedicated channel of a non-serving cell, or a second mode in which the UE communicates using both the non-UE-dedicated channel and the UE-dedicated channel; and transmitting or receiving a communication using the TCI state.
Aspect 13: The method of Aspect 12, wherein the UE supports no more than one active TCI state for inter-cell beam management, and wherein the method includes receiving a medium access control control element (MAC CE) or a radio resource control message that indicates that the UE is to switch from the first mode to the second mode, to switch from the second mode to the first mode, or to operate in both the first mode and the second mode.
Aspect 14: The method of Aspect 12 or 13, wherein, if the UE is operating in the first mode, the TCI state is associated with the serving cell and the non-UE-dedicated channel is of the serving cell.
Aspect 15: The method of Aspect 12 or 13, wherein, if the UE is operating in the first mode, the TCI state is associated with the non-serving cell and the UE-dedicated channel is of the non-serving cell.
Aspect 16: The method of any of Aspects 12-15, wherein the UE is operating in the first mode, and wherein receiving the indication includes: receiving a medium access control control element (MAC CE) that activates the TCI state for the non-UE-dedicated channel of the serving cell; and receiving a MAC CE that activates the TCI state for the UE-dedicated channel of the non-serving cell.
Aspect 17: The method of Aspect 16, wherein a rule for the first mode specifies that the UE does not receive the non-UE-dedicated channel of the serving cell if the TCI state is activated for the UE-dedicated channel of the non-serving cell.
Aspect 18: The method of Aspect 16, wherein a rule for the first mode specifies that the UE receives the non-UE-dedicated channel of the serving cell using the TCI state that is activated for the UE-dedicated channel of the non-serving cell.
Aspect 19: The method of Aspect 16, wherein a rule for the first mode specifies that the UE does not receive the UE-dedicated channel of the non-serving cell if the TCI state is activated for the non-UE-dedicated channel of the serving cell.
Aspect 20: The method of Aspect 16, wherein a rule for the first mode specifies that the UE receives the UE-dedicated channel of the non-serving cell using the TCI state that is activated for the non-UE-dedicated channel of the serving cell.
Aspect 21: The method of Aspect 12 or 13, wherein the UE is operating in the second mode, and wherein the TCI state is associated with the serving cell.
Aspect 22: The method of Aspect 12, 13 or 21, wherein the UE is operating in the second mode, and wherein receiving the indication includes receiving a first medium access control control element (MAC CE) that activates the TCI state.
Aspect 23: The method of Aspect 22, further comprising receiving a second MAC CE that updates the TCI state.
Aspect 24: The method of any of Aspects 12-23, wherein the TCI state is for the UE-dedicated channel of the non-serving cell, and wherein the method includes: receiving another indication to switch to another TCI state for the non-UE-dedicated channel of the serving cell; and switching back to the TCI state for the UE-dedicated channel of the non-serving cell upon expiration of a timer.
Aspect 25: The method of any of Aspects 12-23, wherein the TCI state is for the UE-dedicated channel of the non-serving cell, and wherein the method includes: switching, according to a periodic switching configuration, to another TCI state for the non-UE-dedicated channel of the serving cell; and switching back to the TCI state for the UE-dedicated channel of the non-serving cell upon expiration of a timer.
Aspect 26: A method of wireless communication performed by a user equipment (UE), comprising: transmitting a UE capability report that indicates a maximum quantity of control resource sets (CORESETs) that the UE is able to support for inter-cell beam management; receiving a configuration that indicates one or more CORESETs that do not exceed the maximum quantity of CORESETs; receiving an indication of a transmission configuration indicator (TCI) state that is activated for the one or more CORESETs; and receiving a communication on at least one CORESET of the one or more CORESETs using the TCI state.
Aspect 27: The method of Aspect 26, wherein the maximum quantity of CORESETs includes a maximum quantity of CORESETs supported per component carrier or a maximum quantity of CORESETs supported among all component carriers.
Aspect 28: The method of Aspect 26, wherein the maximum quantity of CORESETs includes a maximum quantity of CORESETs supported for a non-UE-dedicated search space or a maximum quantity of CORESETs supported for a UE-dedicated search space.
Aspect 29: The method of Aspect 26, wherein the maximum quantity of CORESETs includes a maximum quantity of CORESETs supported for a serving cell or a maximum quantity of CORESETs supported for a non-serving cell.
Aspect 30: A method of wireless communication performed by a base station, comprising: receiving, from a user equipment (UE), a UE capability report that indicates a maximum quantity of control resource sets (CORESETs) that the UE is able to support for inter-cell beam management; transmitting a configuration that indicates a quantity of CORESETs that does not exceed the maximum quantity of CORESETs; transmitting an indication of a transmission configuration indicator (TCI) state that is activated for one or more CORESETs; and transmitting a communication on at least one CORESET of the one or more CORESETs using the TCI state.
Aspect 30: An apparatus for wireless communication at a device, comprising a processor; memory coupled with the processor; and instructions stored in the memory and executable by the processor to cause the apparatus to perform the method of one or more of Aspects 1-29.
Aspect 31: A device for wireless communication, comprising a memory and one or more processors coupled to the memory, the one or more processors configured to perform the method of one or more of Aspects 1-29.
Aspect 32: An apparatus for wireless communication, comprising at least one means for performing the method of one or more of Aspects 1-29.
Aspect 33: A non-transitory computer-readable medium storing code for wireless communication, the code comprising instructions executable by a processor to perform the method of one or more of Aspects 1-29.
Aspect 34: A non-transitory computer-readable medium storing a set of instructions for wireless communication, the set of instructions comprising one or more instructions that, when executed by one or more processors of a device, cause the device to perform the method of one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
a memory; and
one or more processors, coupled to the memory, configured to:
receive an indication of a transmission configuration indicator (TCI) state for non-UE-dedicated communication on a physical channel, the TCI state being shared with UE-dedicated communication on the physical channel or not shared with UE-dedicated communication on the physical channel based at least in part on a rule; and
transmit or receive a communication using the TCI state.

2. The UE of claim 1, wherein the rule specifies that the TCI state is shared with UE-dedicated communication on the physical channel for inter-cell beam management or for intra-cell beam management.

3. The UE of claim 1, wherein the rule specifies that the TCI state is shared with UE-dedicated communication on a physical channel for inter-cell beam management and not for intra-cell beam management.

4. The UE of claim 1, wherein the rule specifies that the TCI state is shared with UE-dedicated communication on a physical channel for intra-cell beam management and not for inter-cell beam management.

5. The UE of claim 1, wherein the physical channel is a physical uplink channel or a physical downlink channel, and wherein the rule specifies that the TCI state is shared with UE-dedicated communication on the physical uplink channel or the physical downlink channel.

6. The UE of claim 1, wherein the rule specifies that the TCI state is shared with UE-dedicated communication on a physical uplink channel and not shared with UE-dedicated communication on a physical downlink channel.

7. The UE of claim 1, wherein the rule specifies that the TCI state is shared with UE-dedicated communication on a physical downlink channel and not shared with UE-dedicated communication on a physical uplink channel.

8. The UE of claim 1, wherein the TCI state is shared between UE-dedicated communication on the physical channel and non-UE-dedicated communication on the physical channel, and wherein the one or more processors, to receive the indication of the TCI state, are configured to receive the indication of the TCI state via a medium access control control element (MAC CE) or downlink control information.

9. The UE of claim 1, wherein the TCI state is not shared between UE-dedicated communication on the physical channel and non-UE-dedicated communication on the physical channel, and wherein the one or more processors, to receive the indication of the TCI state, are configured to receive the indication of the TCI state via a medium access control control element (MAC CE) or a radio resource control message.

10. The UE of claim 1, wherein the TCI state is a unified TCI state that indicates a common beam for at least one downlink channel or downlink reference signal (RS) and at least one uplink channel or uplink RS.

11. The UE of claim 1, wherein the TCI state is a unified TCI state that indicates a common beam for more than one downlink channel or downlink RS or more than one uplink channel or uplink RS.

12. A user equipment (UE) for wireless communication, comprising:
a memory; and
one or more processors, coupled to the memory, configured to:
receive an indication to activate a transmission configuration indicator (TCI) state of the UE, the UE operating in one or more of:
a first mode in which the UE switches in a time domain between communicating using a non-UE-dedicated channel of a serving cell and communicating using a UE-dedicated channel of a non-serving cell, or
a second mode in which the UE communicates using both the non-UE-dedicated channel and the UE-dedicated channel; and
transmit or receive a communication using the TCI state.

13. The UE of claim 12, wherein the UE supports no more than one active TCI state for inter-cell beam management, and wherein the one or more processors are configured to receive a medium access control control element (MAC CE) or a radio resource control message that indicates that the UE is to switch from the first mode to the second mode, to switch from the second mode to the first mode, or to operate in both the first mode and the second mode.

14. The UE of claim 12, wherein, if the UE is operating in the first mode, the TCI state is associated with the serving cell and the non-UE-dedicated channel is of the serving cell.

15. The UE of claim 12, wherein, if the UE is operating in the first mode, the TCI state is associated with the non-serving cell and the UE-dedicated channel is of the non-serving cell.

16. The UE of claim 12, wherein the UE is operating in the first mode, and wherein the one or more processors, to receive the indication, are configured to:
receive a medium access control control element (MAC CE) that activates the TCI state for the non-UE-dedicated channel of the serving cell; and
receive a MAC CE that activates the TCI state for the UE-dedicated channel of the non-serving cell.

17. The UE of claim 16, wherein a rule for the first mode specifies that the UE does not receive the non-UE-dedicated channel of the serving cell if the TCI state is activated for the UE-dedicated channel of the non-serving cell.

18. The UE of claim 16, wherein a rule for the first mode specifies that the UE receives the non-UE-dedicated channel of the serving cell using the TCI state that is activated for the UE-dedicated channel of the non-serving cell.

19. The UE of claim 16, wherein a rule for the first mode specifies that the UE does not receive the UE-dedicated channel of the non-serving cell if the TCI state is activated for the non-UE-dedicated channel of the serving cell.

20. The UE of claim 16, wherein a rule for the first mode specifies that the UE receives the UE-dedicated channel of the non-serving cell using the TCI state that is activated for the non-UE-dedicated channel of the serving cell.

21. The UE of claim 12, wherein the UE is operating in the second mode, and wherein the TCI state is associated with the serving cell.

22. The UE of claim 12, wherein the UE is operating in the second mode, and wherein receiving the indication includes receiving a first medium access control control element (MAC CE) that activates the TCI state.

23. The UE of claim 22, wherein the one or more processors are configured to receive a second MAC CE that updates the TCI state.

24. The UE of claim 12, wherein the TCI state is for the UE-dedicated channel of the non-serving cell, and wherein the one or more processors are configured to:
receive another indication to switch to another TCI state for the non-UE-dedicated channel of the serving cell; and
switch back to the TCI state for the UE-dedicated channel of the non-serving cell upon expiration of a timer.

25. The UE of claim 12, wherein the TCI state is for the UE-dedicated channel of the non-serving cell, and wherein the one or more processors are configured to:
switch, according to a periodic switching configuration, to another TCI state for the non-UE-dedicated channel of the serving cell; and
switch back to the TCI state for the UE-dedicated channel of the non-serving cell upon expiration of a timer.

26. A user equipment (UE) for wireless communication, comprising:
a memory; and
one or more processors, coupled to the memory, configured to:
transmit a UE capability report that indicates a maximum quantity of control resource sets (CORESETs) that the UE is able to support for inter-cell beam management;
receive a configuration that indicates one or more CORESETs that do not exceed the maximum quantity of CORESETs;
receive an indication of a transmission configuration indicator (TCI) state that is activated for the one or more CORESETs; and
receive a communication on at least one CORESET of the one or more CORESETs using the TCI state.

27. The UE of claim 26, wherein the maximum quantity of CORESETs includes a maximum quantity of CORESETs supported per component carrier or a maximum quantity of CORESETs supported among all component carriers.

28. The UE of claim 26, wherein the maximum quantity of CORESETs includes a maximum quantity of CORESETs supported for a non-UE-dedicated search space or a maximum quantity of CORESETs supported for a UE-dedicated search space.

29. The UE of claim 26, wherein the maximum quantity of CORESETs includes a maximum quantity of CORESETs supported for a serving cell or a maximum quantity of CORESETs supported for a non-serving cell.

30. A base station for wireless communication, comprising:
a memory; and
one or more processors, coupled to the memory, configured to:
receive, from a user equipment (UE), a UE capability report that indicates a maximum quantity of control resource sets (CORESETs) that the UE is able to support for inter-cell beam management;
transmit a configuration that indicates a quantity of CORESETs that does not exceed the maximum quantity of CORESETs;
transmit an indication of a transmission configuration indicator (TCI) state that is activated for one or more CORESETs; and
transmit a communication on at least one CORESET of the one or more CORESETs using the TCI state.
